(19) United States
(12) Patent Application Publication
(10) Pub. No.: US 2018/0070768 A1
(43) Pub. Date: Mar. 15, 2018

(54) COOKING DEVICE

(71) Applicant: Spectrum Brands, Inc., Middleton, WI (US)

(72) Inventors: Byron Seth SAWYER, Middleton, WI (US); Nicole Ann SORENSON, Verona, WI (US); Daniel PROVOLO, Middleton, WI (US)

(73) Assignee: Spectrum Brands, Inc., Middleton, WI (US)

(21) Appl. No.: 15/555,795

(22) PCT Filed: Mar. 4, 2016
(86) PCT No.: PCT/US2016/020997

§ 371 Date: Sep. 5, 2017

Related U.S. Application Data
(60) Provisional application No. 62/128,933, filed on Mar. 5, 2015.

(51) Int. Cl. A47J 37/06; A47J 27/00

(52) U.S. Cl. CPC A47J 37/06; A47J 27/002

(57) ABSTRACT

A cooking device is disclosed which combines a flat griddle surface and a ribbed grill surface within the same plate structure so that multiple types of food can be cooked simultaneously by the same cooking device. In one example, the cooking device has a central flat cooking surface and two adjacent side ribbed grill surfaces that extend at a sloped or downward angle from the flat cooking surface. This configuration allows for liquids, such as grease, to efficiently drain from each of the flat and ribbed cooking surfaces.

This application is being filed on 4 Mar. 2016, as a PCT International patent application, and claims priority to U.S. Provisional Patent Application No. 62/128,933, filed on Mar. 5, 2015, the disclosure of which is hereby incorporated by reference in its entirety.

### BACKGROUND

Devices and appliances for heating and cooking food products are known. Some heating appliances provide a heated cooking surface onto which the food products are placed. Sometimes the cooking surface is heated by electricity, such as by an electric resistance heater. For some devices, the cooking surface is provided with a flat or planar surface such that the cooking surface acts as a griddle for cooking foods such as pancakes, French toast, bacon, and eggs. In other devices, the cooking surface is provided with raised ribs such that the cooking surface acts as a grill for cooking foods such as steaks, hamburgers, and chops, wherein the ribs help to separate the food from grease that may be produced during cooking.

### SUMMARY

In general terms, this disclosure is directed to a cooking device. In one possible configuration and by non-limiting example, the cooking device is configured with a cooking surface that includes both a flat portion acting as a griddle and a sloped, ribbed portion acting as a grill. Various aspects are described in this disclosure, which include, but are not limited to, the following aspects.

One aspect is a cooking device including: a base structure and a plate structure supported by the base structure. The plate structure may include: opposite first and second sides extending between opposite front and back sides; a top cooking surface including a first portion and a second portion disposed at an angle relative to the first portion, wherein the first portion has a generally planar surface and the second portion has a ribbed surface; a bottom surface opposite the top cooking surface; and a first drain aperture extending through the plate structure, the drain aperture being located within the top cooking surface second portion and proximate the first and front sides.

In another aspect, the cooking device can be provided with a top cooking surface that includes a third portion disposed at an angle relative to the first portion, wherein the third portion has a ribbed surface and includes a second drain aperture extending through the plate structure that is located proximate the second and front sides. In yet another aspect, the first portion of the top cooking surface can define a first plane, wherein the second and third portions extend from the first portion to the first and second sides, respectively, at a first angle below the first plane. In one aspect, the ribbed surfaces of the second and third portions of the top cooking surface can each include a plurality of spaced apart ribs that are oriented at an oblique angle with respect to the front side of the plate structure to direct fluids towards the first and second drain apertures, respectively.

In a further aspect, the cooking device may include a removable drain tray located beneath the drain aperture, wherein the removable tray being supported by one or both of the base structure and the plate structure. The cooking device may also be provided with a heating element disposed adjacent the bottom surface of the plate structure.

### BRIEF DESCRIPTION OF THE DRAWINGS

FIG. 1 is a top perspective view of the example cooking device.

FIG. 2 is a top view of the example cooking device shown in FIG. 1.

FIG. 3 is a cross-sectional view of the example cooking device shown in FIG. 1, taken along the line 3-3 shown in FIG. 2.

FIG. 4 is a front side view of the example cooking device shown in FIG. 1.

FIG. 5 is a first side view of the example cooking device shown in FIG. 1.

FIG. 6 is a second side view of the example cooking device shown in FIG. 1.

FIG. 7 is a bottom side view of the example cooking device shown in FIG. 1.

FIG. 8 is a bottom perspective view of the example cooking device shown in FIG. 1.

FIG. 9 is a top perspective view of the example cooking device shown in FIG. 1, with the drain trays thereof removed.

FIG. 10 is an exploded top perspective view of the example cooking device shown in FIG. 1.

FIG. 11 is an exploded bottom perspective view of the example cooking device shown in FIG. 1.

FIG. 12 is a side view of the first support structure of the example cooking device shown in FIG. 1.

FIG. 13 is a side view of the first support structure of the example cooking device shown in FIG. 1.

FIG. 14 is an enlarged view of a portion of the example cooking device shown in FIG. 11.

FIG. 15 is an enlarged view of a portion of the example cooking device shown in FIG. 11

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

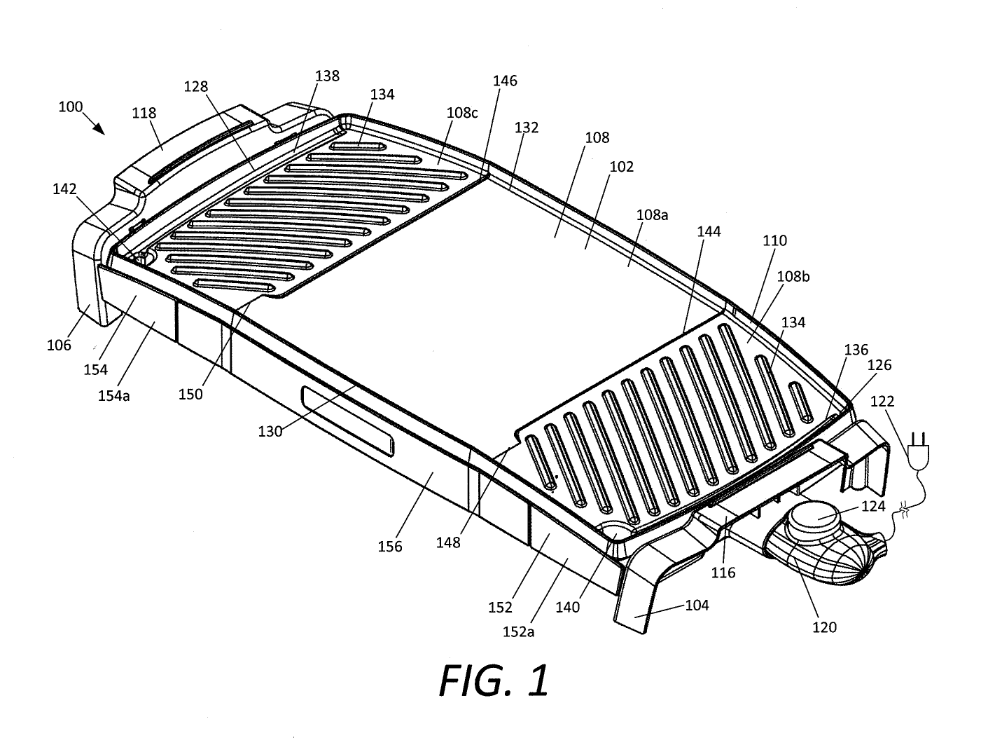

Referring to FIGS. 1-8, an assembled exemplary cooking device 100 is shown. FIG. 1 shows a perspective view of the cooking device 100 where it can be seen that the cooking device 100 includes a plate structure 102. As shown, the plate structure 102 defines a top cooking surface 108 that can be heated and used for cooking a food product. The plate structure 102 can also be provided with a raised rim 110 surrounding the top cooking surface 108 that functions to keep the food product and liquids, such as grease, from spilling off of the top cooking surface 108. The plate structure 102 may be formed from a variety of materials, such as steel, iron, or aluminum. The plate structure 102 may also be provided with a coating, such as a ceramic coating, such that the top cooking surface 108 and raised rim 110 are covered with a finish material that is different from the material that from which the plate structure 102 is formed. Other coatings or surfaces may also be used or formed. For example, polytetrafluoroethylene (PTFE, e.g. TEFLON®), silicone, enamels, anodizing, and other non-stick coatings may be used.

The cooking device 100 may also be provided with a first support structure 104 and a second support structure 106 that together form a base structure for supporting the plate structure 102. The support structures 104, 106 provide a platform upon which the cooking device 100 can be supported by a flat surface, such as a table or countertop. The support structures 104, 106 also allow a user to lift and transport the cooking device 100 via handle portions 116, 118, respectively. The cooking device 100 may also be provided with one or more skirts 156 to conceal the bottom side of the cooking device 100 from view so as to provide an improved aesthetic appearance to the cooking device 100. As shown, a front skirt 156 is provided proximate the front side 130. Optionally, a back skirt may also be provided proximate the back side 132. In one example, each of the support structures 104, 106 and/or the front skirt 156 are formed from a polymeric material, such as ABS plastic, wherein the individual components are mounted to the plate structure 102.

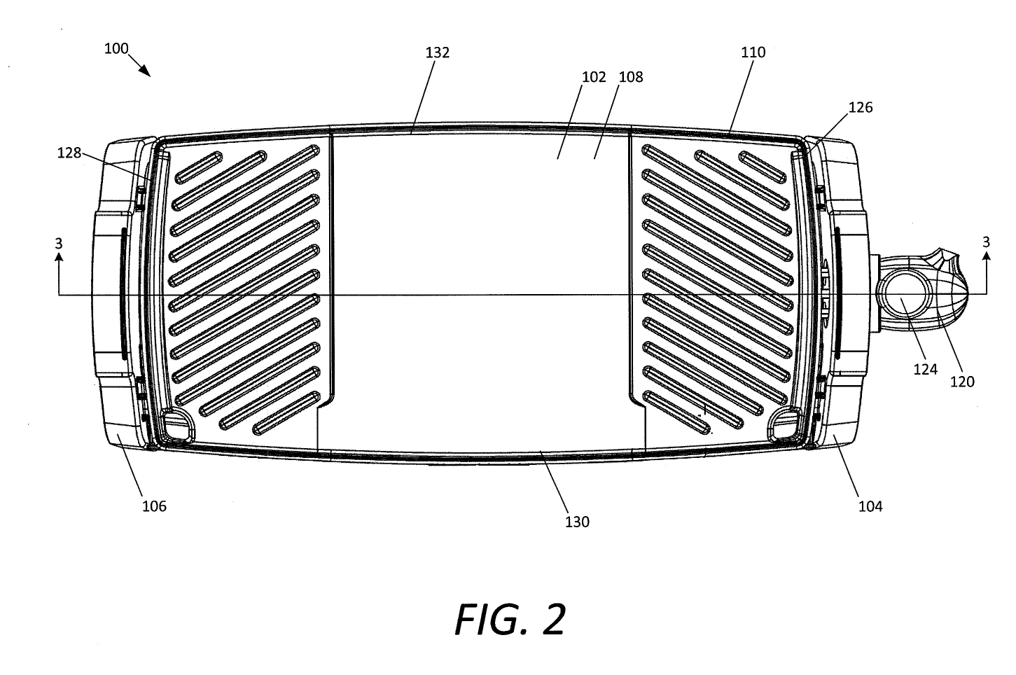

The cooking device 100 may also be provided with a heating and control device 120. The heating and control device 120 is for providing a controlled heat source to the plate structure 102 such that the top cooking surface 108 has sufficient heat to cook a food product. The heating and control device 120 can be provided with a plug 122 for connection to an electrical socket. The plug 122 can be configured to interface with a variety of different electrical sockets, for example any of plug Types A through O, as defined by the US Department of Commerce International Trade Administration. The heating and control device 120 can also be provided with a control knob or dial 124 for turning the cooking device 100 on and off and for allowing a user to select a desired temperature for the top cooking surface 108. Although the heating and control device 120 is shown as being provided with a rotating control knob, any type of suitable switch, selector, or user interface may be utilized. The heating and control device 120 can also be configured to work with a variety of power sources, for example, power sources having a frequency of 50 Hertz (Hz) or 60 Hz and power sources having a voltage of 110 volts (V), 115 V, 120 V, 127 V, 220 V, 230 V, or 240 V. Other frequencies and voltages may also be accommodated by the heating and control device 120. Referring to FIGS. 1 and 2, the plate structure 102 is shown as extending between a first side 126 and an opposite second side 128. The plate structure 102 is also shown as extending between a front side 130 and an opposite back side 132. As configured, the top cooking surface 108 of the plate structure 102 may be provided with a first portion 108a in the central region of the top cooking surface 108 and provided with an adjacent second portion 108b extending from the first side 126 to the first portion 108a. The top cooking surface 108 may also be provided with a third portion 108c adjacent the first portion 108a and extending to the second side 128.

The first portion 108a may be configured as a griddle having a generally planar surface. The second and third portions 108b, 108c may be configured as a grill in which a plurality of spaced apart raised ribs 134 is provided to form a ribbed surface. It is noted that the first portion 108a is disposed generally horizontally when the cooking device 100 is placed on a level surface. In one example, the first portion 108a is completely flat and horizontal such that a user would need to use a spatula or other tool to direct grease towards the front side 130. However, it is noted that the first portion 108a may be disposed at a slight downward angle from the back side 132 towards the front side 130 to encourage liquids, such as grease, to flow towards the front side 103. As shown, the ribs 134 are arranged in parallel fashion. However, the ribs 134 may be provided in different configurations, for example a v-type configuration in which a first group of parallel or generally aligned ribs are angled towards a second group of parallel or generally aligned ribs, and in which a passageway and/or drain channel is provided between the first and second groups of ribs.

In one aspect, the second and third portions 108b, 108c of the top cooking surface are sloped and/or angled downwardly and away from the first portion 108a towards the first and second sides 126, 128, respectively. This configuration allows for liquids, such as grease, to drain off of the first portion 108a and across the second and third portions 108b, 108c towards the respective first and second sides 126, 128. Additionally, the raised ribs 134 are oriented such that the ribs 134 extend obliquely from the back side 132 towards the front side 130. This arrangement further guides draining liquids towards the front side 130 of the top cooking surface 108.

As most easily viewed at FIG. 2, a first drain channel 136 extends along the first side 126 of the plate structure 102 and a second drain channel 138 extends along the second side 128 of the plate structure 102. Each of the drain channels 136, 138 is configured to extend and slope downwardly from the back side 132 towards the front side 130. As shown, each of the drain channels 136, 138 extends to a respective drain aperture 140, 142 located in the front corners of the top cooking surface 108, proximate the front side 130 and the first and second sides 126, 128, respectively. The drain apertures 140, 142 extend through the plate structure 102 such that any collected liquids will drain through the plate structure 102. It is noted that the drain apertures 140, 142 could also be provided at other locations along the first and second sides 126, 128, for example proximate the back side 132 or at a midway point between the front and back sides 130, 132. In such a case, the drain channels 136, 138 would be sloped to the drain apertures 140, 142 accordingly. Additional drain channels could also be provided along all or a portion of the front and back sides 130, 132. For example, front and back drain channels could be provided along only on the first portion 108a of the top cooking surface, or could be provided along the first, second, and third portions 108a, 108b, 108c of the top cooking surface. In one example, the entire perimeter of the top cooking surface 108 can be provided with a drain channel(s) extending to one or more drain apertures.

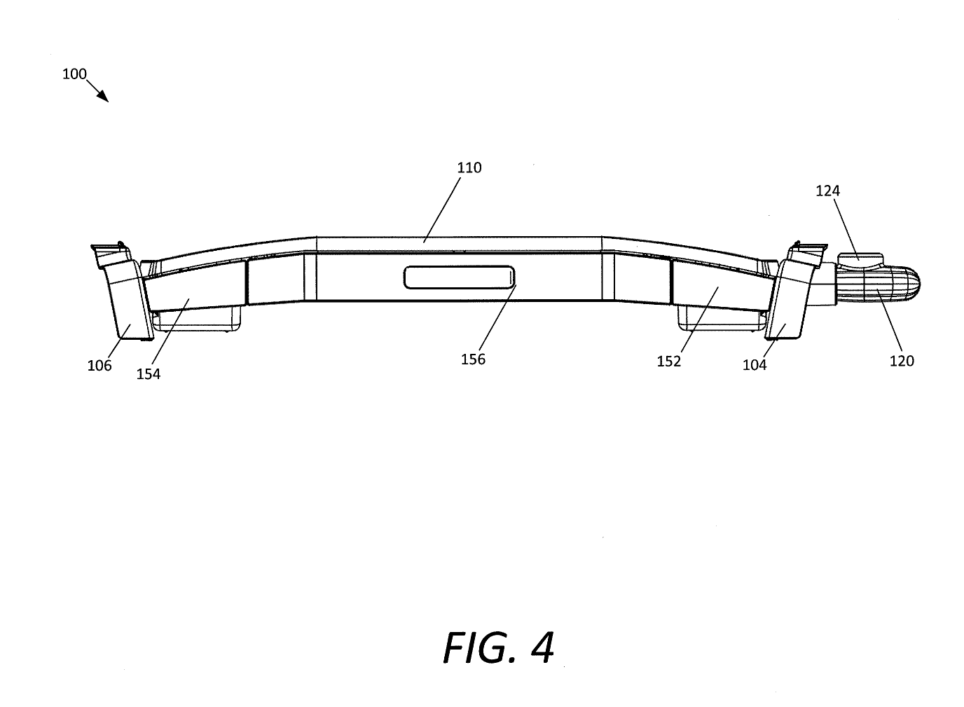

Referring back to FIG. 1 a first drain tray 152 is provided beneath the first drain aperture 140 while a second drain tray 154 is provided beneath the second drain aperture 142. Each of the drain trays 152, 154 is configured to be slidably removable from the plate structure 102 from the front side 130 which provides for ease of access to a user. In the views shown at FIGS. 1 and 4, it can be seen that the front faces 152a, 154a of the drain trays 152, 154 are generally aligned with the front skirt 156 to provide a continuous appearance across the front side 130. The front faces 152a, 154a also function as a handle that a user can grasp when handling the drain trays 152, 154.

Referring to FIGS. 1 and 2, it can be seen that a first ridge line 144 is provided between the first and second portions 108a, 108b of the top cooking surface 108 and a second ridge line 146 is provided between the first and third portions 108a, 108c of the top cooking surface 108. The ridge lines 144, 146 extend from the back side 132 and towards the front side 130. However, the ridge lines 144, 146 stop short of the front side 130 to form respective passageways 148, 150, wherein the juncture between the first and second portions 108a, 108b and first and third portions 108a, 108c are at the same elevation. The ridge lines 144, 146 can be formed by recessing part of the first portion 108a below second and third portions 108b, 108c, or by providing a separate raised element. The ridge lines 144, 146 provide a limited barrier to liquids accumulated on the first portion 108a such that the liquids are guided onto the second and third portions 108b, 108c proximate the front side 130.

With the disclosed configuration, any liquids formed on the first portion 108a can be guided towards the front side 130 when pushed with a utensil by a user, where the liquids can then flow down either of the second and third portions 108b, 108c, via passageways 148, 150, and towards the drain apertures 140, 142. As the ribs 134 do not extend fully towards the front side 130, an unobstructed pathway exists between the passageways 148, 150 and the drain apertures 140, 142. For liquids collected on the second and third portions 102b, 102c, the liquids will be guided between the raised ribs 134 and towards the front side 130 and respective sides 126, 128 and into the drain channels 136, 138. Once in the drain channels 136, 138, the liquid will drain through the drain apertures 140, 142 and into the drain trays 152, 154.

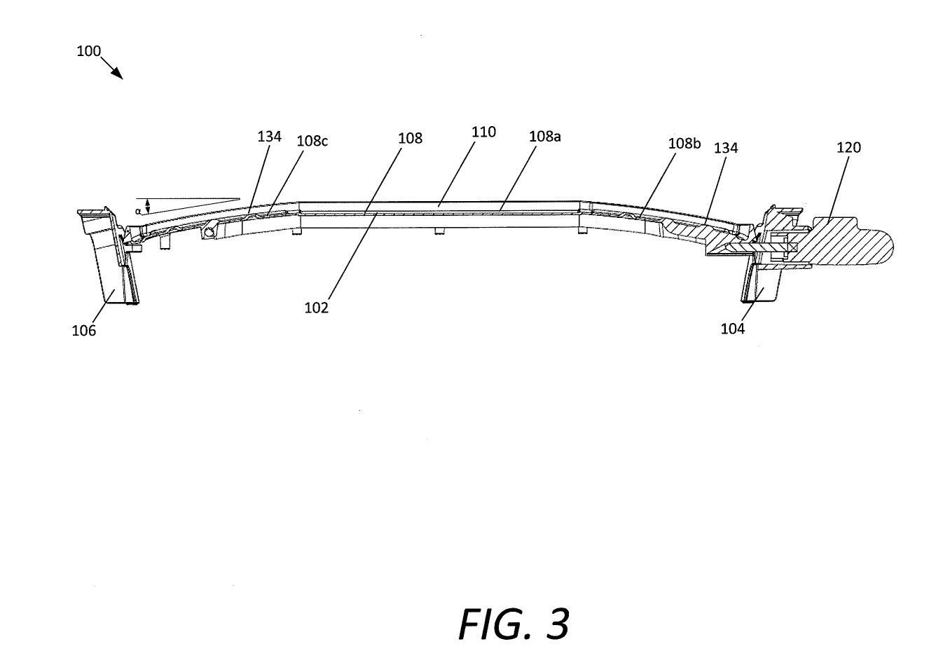

Referring to FIG. 3, the angle formed between the first portion 108a of the top cooking surface 108 with respect to the second and third portions 108b, 108c is shown in greater detail. As shown, the first portion 108a of the top cooking surface 108 defines a first plane while the second and third portions 108b, 108c extend downwardly from the first portion 108a at a first angle α such that the second and third portions 108b, 108c at the first and second sides 126, 128 are below the first portion 108a. In the example embodiment shown, the first angle α is between about 5 and 15 degrees, for example about 8 degrees. It is noted that each of the second and third portions 108b, 108c may be provided with a slightly curved profile that is generally presented at the angle α, as can be viewed in cross-section at FIG. 3, or may alternatively be provided with a completely straight profile.

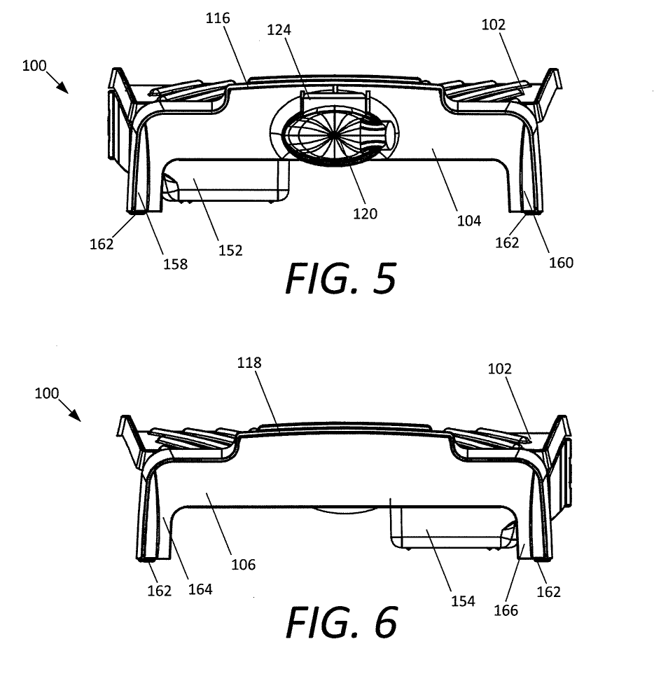

FIG. 5 shows an end view of the first support structure 104, where it can be seen that the first support structure 104 may be provided with a pair of legs 158, 160. The legs 158, 160 are for supporting the cooking device 100 on a surface, such as a counter top. The legs 158, 160 also provide the cooking device 100 with a desired height from the surface upon which the cooking device 100 is supported. In the example shown, the legs 158, 160 are provided with feet 162 to increase the friction between the legs 158, 160 and the surface such that the cooking device 100 will not easily slide with respect to the surface. In one example, the feet 162 are formed from a rubber material that inserted into or onto the legs 158, 160. FIG. 6 shows the same features for the second support structure 106, in which legs 164, 166 are provided that also utilize feet 162.

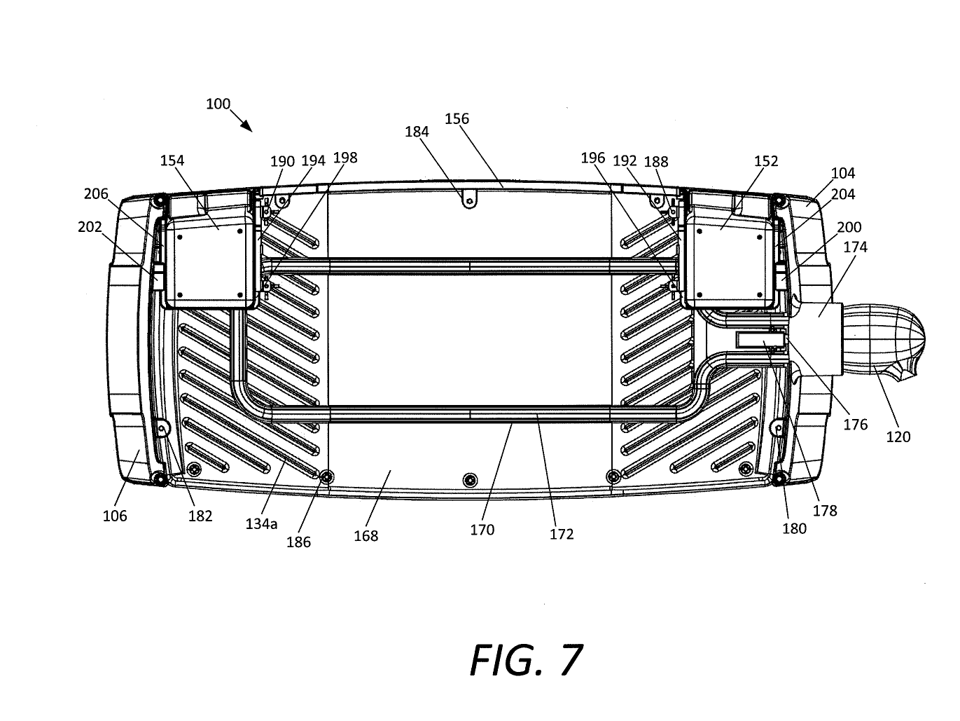

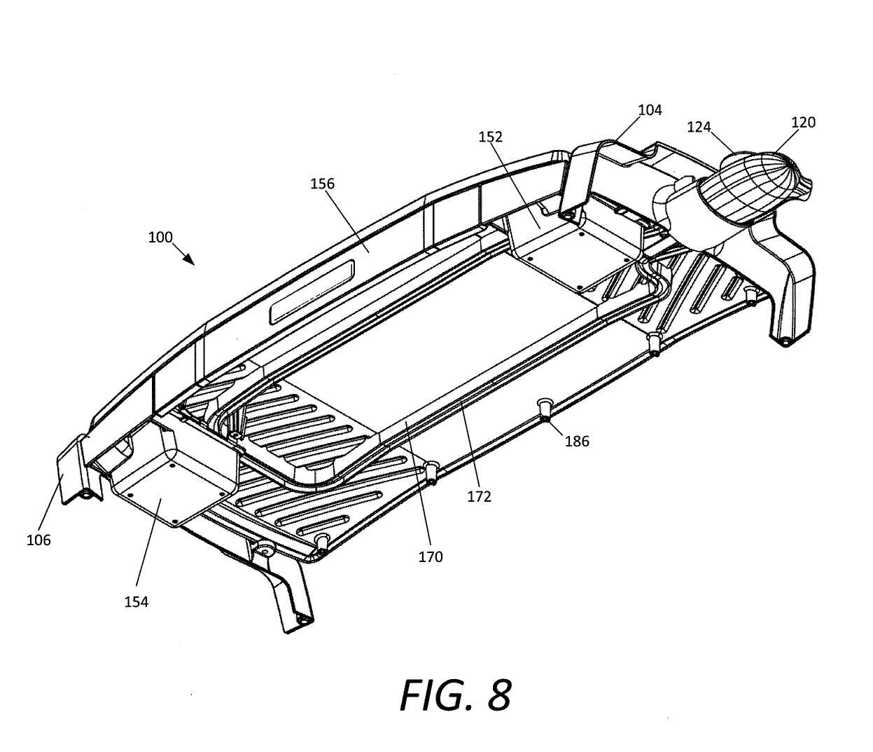

FIGS. 7 and 8 show the exemplary cooking device 100 from a bottom perspective. As shown, the plate structure 102 has a bottom side 168 opposite the top cooking surface 108. As shown, the bottom side 168 is provided with a channel 170 for receiving a heating element 172, for example an electrical tubular resistance heater (e.g. a CALROD® type heater). Many other types of electric heating elements 172 may be utilized. For example, infrared heaters, convection-type heaters, wire heaters, and induction-type heaters. Additionally, the heating element 172 and the plate structure 102 may be entirely integral such that the control device 120 provides an electric current to the plate structure 102 for heating. Non-electric heating elements 172 may also be used, if desired. In one example, the heating element 172 is inserted into the channel 170 and then secured within the channel 170, for example by crimping the top edges of the channel 170 onto the heating element 172. This construction allows for the heating element 172 to be held in close proximity to the bottom side 168 such that heating can be efficiently delivered to the top cooking surface 108.

In the example shown, the heating element 172 extends across the bottom side 168 of the plate structure 102 such that the heating element 172 is beneath each of the first, second, and third portions 108a, 108b, 108c of the top cooking surface 108. In an alternative example, multiple heating elements 172 that are separately controllable can be provided such that a first heating element portion extends beneath the first portion 108a and a second heating element portion extends beneath the second and third portions 108b, 108c. A third heating element portion can also be provided such that the second and third portions 108b, 108c are provided with separate heating element portions. In these configurations, the heating and control device 120 can be configured to allow a user to independently control each of the separate heating elements such that the temperature of each of the portions 108a, 108b, 108c of the top cooking surface 108 is maintained at a desired level.

FIGS. 7 and 8 also show that the first support structure 104 can be provided with a mounting receptacle 174 for receiving the heating and control device 120 which may be provided with a temperature probe 176 for thermostatic control of the heating and control device 120. A shielding member 178 may also be provided to improve the accuracy of the temperature probe 176 in sensing the temperature of the plate structure 102. The temperature sensed at this location is used as a proxy for the temperature of the top cooking surface 108. Where multiple heating elements 172 are provided, multiple temperature probes 172, which may be remote from the heating and control device 120, may be utilized. With continued reference to FIGS. 7 and 8, it can be seen that the raised ribs 134 can be provided with a recessed portion 134a that gives the ribs 134 a hollowed profile or shape rather than being formed as solid structures. This configuration allows for the thickness of the material forming the ribs 134 to be generally the same as the thickness of the material forming the remainder of the plate structure 102, for example the first portion 108a and the spaces between the ribs 134 on the second and third portions 108b, 108c, resulting in more even temperature distribution across the entire top cooking surface 108.

FIGS. 7 and 8 further show a plurality of mounting locations where the various components of the cooking device 100 are attached to the plate structure 102. These mounting locations can include a raised portion of the plate structure 102, an aperture in the structure mounted to the plate structure 102, and a mechanical fastener, such as a screw, for connecting the component to the plate structure 102. For example, mounting locations 180 can be provided to secure the first support structure 104 to the plate structure 102 while mounting locations 182 can be provided to secure the second support structure 106 to the plate structure 102. Mounting locations 184 may also be provided to mount the front skirt 156 to the plate structure 102 while mounting locations 186 may be provided for mounting the optional back skirt to the plate structure 102.

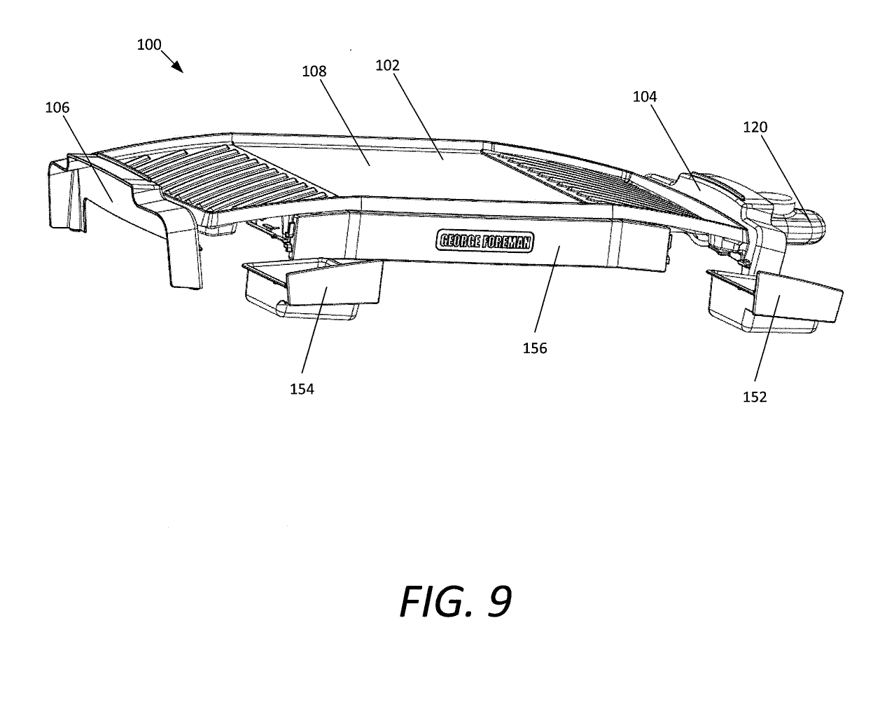

Mounting locations 188, 190 may also be provided to secure brackets 192, 194 to the plate structure 102. The mounting brackets 192, 194 provide a shelf or ledge upon which a respective lip 196, 198 of the drain trays 152, 154 may rest. For a similar purpose, the support structures 104, 106 can be provided with a respective shelf or ledge tab 200, 202 to support a lip 204, 206 on an opposite side of the drain trays 152, 154. Taken together, the brackets 192, 194 and the tabs 200, 202 act as a support structure for the drain trays 152, 154 upon which the drain trays 152, 154 can slide between open and closed positions. This structure also allows for the drain trays 152, 154 to be easily removable from the front 130 such that collected liquid can be readily disposed without requiring movement of the cooking device 100. This operation is illustrated at FIG. 9, where the drain trays 152 are shown as having been slid out from under the plate structure 102 and separated from the cooking device 100.

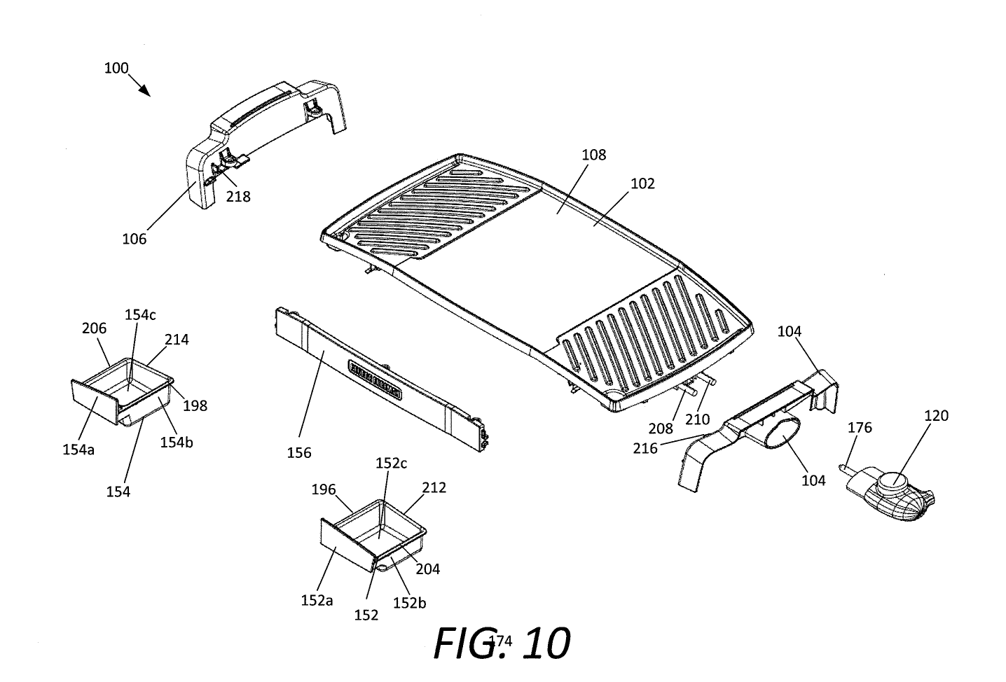

FIGS. 9 and 10 are exploded views of the cooking device 100 and show elements of the individual components of the cooking device 100 in further detail. In particular, it can be seen that the heating element 172 includes a first end 208 and a second end 210. The first and second ends 208, 210 are configured to be inserted into the heating and control device 120 so that the heating and control device 120 can apply an electrical current to the heating element 172. FIG. 10 also shows the temperature probe 176 of the heating and control device 120 in further detail. The lips 196/204 and 198/206 of the respective drain trays 152, 154 can also be more clearly seen at FIG. 10, where it is also shown that the drain trays 152, 154 can also include a respective rear lip 212, 214. The drain trays 152, 154 can also be seen as having an open top defined respectively by sidewalls 152b, 154b that connect to a bottom surface 152c, 154c.

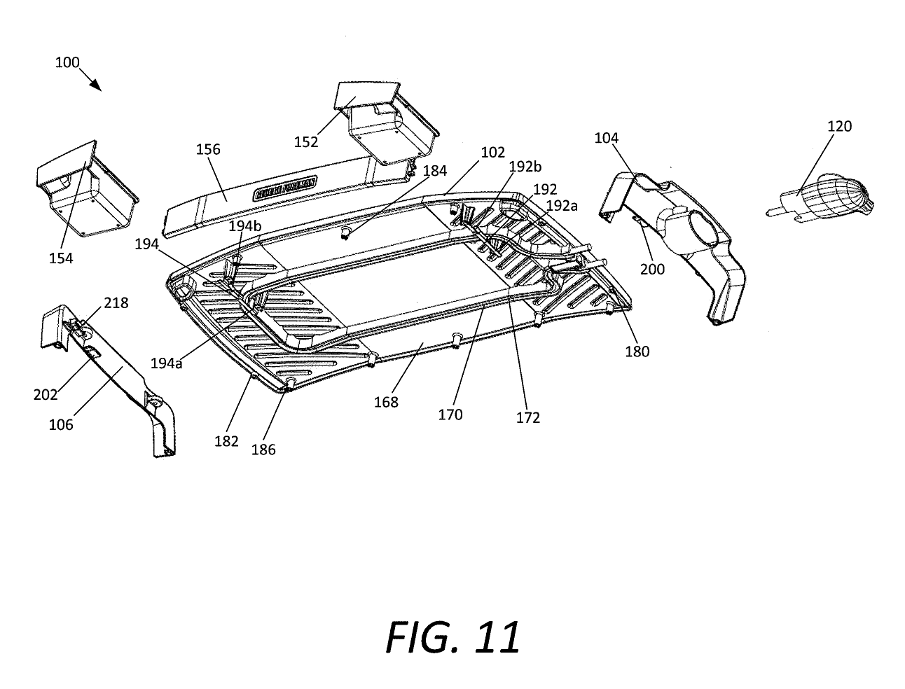

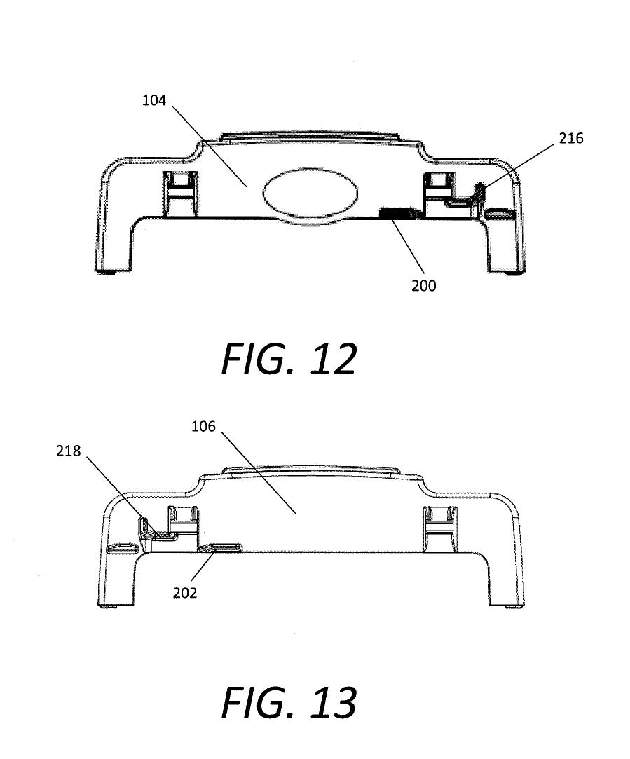

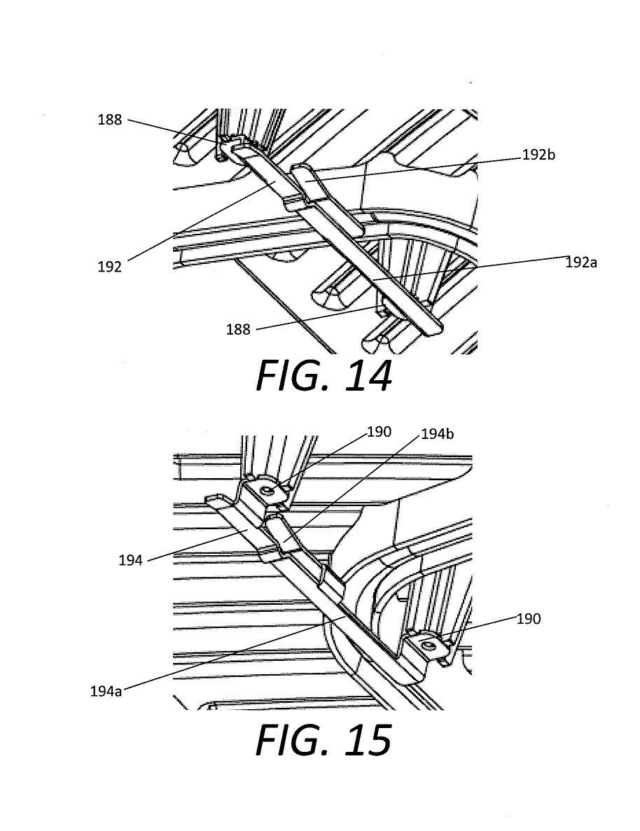

FIGS. 10 and 11 also show that the brackets 192 and 194 can be provided with a respective lower and upper retention member 192a/194a and 192b/194b while the first and second support structures 104, 106 can also be provided with upper retention members 216, 218. The upper retention members 216, 218 are most clearly shown at FIGS. 12 and 13 while the brackets 192, 194 are most clearly shown in the enlarged views provided at FIGS. 14 and 15. The upper retention members 192b/194b and 216/218 are disposed over the lips 196/204 and 198/206 while lower members 192a, 194a and tabs 200, 202 support the tray lips 196/204 and 198/206 from beneath, as discussed previously. In this configuration, the upper retention members 192b/194b and 216/218 operate to vertically constrain the trays 152, 154 such that the trays 152, 154 are sufficiently guided when sliding in and out of the cooking device 100.

The heating and control device 120 may be configured for analog operation, digital operation, or a combination of analog and digital operation. For example, the heating and control device 120 may be configured such that the heating element 172, temperature probe 176 and control knob 124 are electric components that are connected together, along with other components, for analog thermostatic control in which the output of the heating element is solely a function of the control knob setting 124 and the position of the temperature probe 176. Alternatively, the heating and control device 120 can be provided with an electronic processor and memory such that the output to the heating element 176 is further controllable via software. In one example, the heating and control device 120 is provided with a wireless communication device, such as a Wi-Fi chip, to allow a user to remotely control the cooking device 100. In one example, the wireless communication device, allows a user to enable and disable the operation of the heating and control device 120 remotely. In one example, the communication device includes a Wi-Fi chipset includes an on-chip processor and memory such that an additional system level controller is not needed in the heating and control device 120.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A cooking device comprising:
a base structure;
a plate structure supported by the base structure, the plate structure including:
opposite first and second sides extending between opposite front and back sides;
a top cooking surface including a first portion and a second portion disposed at an angle relative to the first portion, wherein the first portion has a generally planar surface and the second portion has a ribbed surface;
a bottom surface opposite the top cooking surface;
a first drain aperture extending through the plate structure, the drain aperture being located within the top cooking surface second portion and proximate the first and front sides; and
a heating element disposed adjacent the bottom surface of the plate structure.

2. The cooking device of claim 1, wherein the plate structure top cooking surface includes a third portion disposed at an angle relative to the first portion, wherein the third portion has a ribbed surface and includes a second drain aperture extending through the plate structure that is located proximate the second and front sides.

3. The cooking device of claim 2, wherein the ribbed surfaces of the second and third portions of the top cooking surface each include a plurality of spaced apart ribs that are oriented at an oblique angle with respect to the front side of the plate structure to direct fluids towards the first and second drain apertures, respectively.

4. The cooking device of claim 2, wherein the first portion of the top cooking surface defines a first plane and the second and third portions extend from the first portion to the first and second sides, respectively, at a first angle below the first plane.

5. The cooking device of claim 1, further including a removable drain tray located beneath the drain aperture, the removable drain tray being supported by one or both of the base structure and the plate structure.

6. The cooking device of claim 1, wherein the base structure includes a first support structure mounted to the plate structure proximate the first side and a second support structure mounted to the plate structure proximate the second side.

7. The cooking device of claim 6, wherein each of the first and second support structures are configured to support the cooking device on a surface.

8. The cooking device of claim 7, wherein each of the first and second support structures includes a handle portion to allow a user to lift the cooking device.

9. The cooking device of claim 1, further including a heating and control device for supplying heat to the heating element, the power and control device including a plug for inserting into an electrical outlet and a temperature probe for sending a temperature of the top cooking surface.

10. The cooking device of claim 9, wherein the power and control device is removable from the plate structure.

11. The cooking device of claim 1, further including a skirt mounted to the bottom surface of the plate structure proximate the front side.

12. The cooking device of claim 1, wherein the plate structure is a ceramic coated aluminum material.

13. The cooking device of claim 1, wherein the bottom surface of the plate structure is formed with a channel, within which the heating element disposed.

14. The cooking device of claim 1, wherein the heating element is an electric tubular heater.

15. The cooking device of claim 2, wherein each of the plurality of spaced apart ribs of the first and third portions are provided with recesses at the bottom side of the plate structure such that each of the plurality of ribs has a sidewall thickness that is about the same as a thickness of the first portion and the parts of the second and third portions between the ribs.

16. The cooking device of claim 2, further including a first drain channel extending along the first side and extending from the back side to the first drain aperture and a second drain channel extending along the second side and extending from the back side to the second drain aperture.

17. The cooking device of claim 16, wherein the first and second drain channels are each sloped downwardly from the back side towards the first and second drain apertures, respectively.

18. The cooking device of claim 3, wherein the first portion is recessed with respect to the second and third portions at a location proximate the back side to form a ridge and is level with the second and third portions at a location proximate the front side such that any fluids accumulated on the first portion are guided towards the front side where the fluids can then drain to the first or second drain apertures via the second and third portions, respectively.

19. The cooking device of claim 5, wherein the removable drain tray is configured to be inserted from the front side beneath the plate structure proximate the bottom side.

20. The cooking device of claim 1, wherein the heating element includes a first element portion located beneath the first top cooking surface portion and a second element portion located beneath the second top cooking surface portion, wherein the first and second element portions are independently controllable.

21. The cooking device of claim 1, wherein the heating element is selected from the group consisting of an electric tubular heater, an infrared heater, a convection-type heater, and an induction-type heater.

22. The cooking device of claim 1, wherein the plate structure is configured as the heating element.

23. The cooking device of claim 9, wherein the heating and control device includes a wireless communication device for allowing a user to remotely control the heating and control device.
